(19) United States
(12) Patent Application Publication
(10) Pub. No.: US 2005/0114713 A1
(43) Pub. Date: May 26, 2005

(54) Automated subscription and purchasing service for a data computing device

(76) Inventors: Shawn Beckman, Paradise Valley, AZ (US); Derek L. Davis, Phoenix, AZ (US); Patricia Beckman, Paradise Valley, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/992,921

(22) Filed: Nov. 19, 2004

Related U.S. Application Data
(60) Provisional application No. 60/525,070, filed on Nov. 25, 2003.

(51) Int. Cl. H04K 1/00

(52) U.S. Cl. 713/202

(57) ABSTRACT

One aspect of an embodiment of the invention relates to a method for substantially mitigating identity fraud. The method comprises (1) transmitting a password to a centralized entity for verification of the subscriber, where the password is unique to a subscriber being a party to a financial transaction. The password is compared to stored information at the centralized entity. If a match is detected, a certificate is provided by the centralized agency. The certificate authorizes access to credit data of the subscriber.

This application claims the benefit of priority on U.S. Provisional Patent Application No. 60/525,070 filed Nov. 25, 2003.

### FIELD

Embodiments of the invention relate to a system and a method for mitigating identity fraud. In particular, one embodiment of the invention relates to a method and system for mitigating the costly effects of identity theft.

### GENERAL BACKGROUND

The most lucrative schemes in use by identity thieves involve acquiring consumer credit or consumer loans in their victims' names. According to a Federal Trade Commission entitled “Federal Trade Commission—Identity Theft Survey Report,” published September 2003, credit card fraud, phone or utility services fraud, and bank fraud combined to make up 81% of all identity theft exploitation in 2002. According to the same FTC report, government and employment related fraud account for 17% of identity theft abuses. The key enabler for an identity thief is the relative ease of access to supposedly secure Private Personal Data (PPD), which is requested in any application to get a loan, establish credit, get a job, or claim government benefits.

Herein, “Private Personal Data” (PPD) is information that uniquely identifies a person as a particular individual. Examples of a PPD include, but are not limited or restricted to (1) a social security number, (2) a date of birth, (3) a driver's license number, or (4) a mother's maiden name. Unfortunately, most types of PPD are inherently insecure because they are permanent in nature, giving a significant edge to ardent perpetrators of identity theft. Compounding the security risk is the fact that the PPD is available as a residual of each transaction that needs its disclosure. During these transactions, the PPD is communicated verbally, either in person or over the phone. It is written down, typed into documents or web pages, copied, stored, and continually accessed by institutions. Over time, the repeated exposure of this permanent PPD substantially increases a person's chances of becoming a victim of identity theft.

In the financial arena, once an identity-thief has access to another person's PPD, there are minimal proactive procedural barriers standing in the way of loan/credit approval and the subsequent fraudulent transaction(s). Once accurate PPD is provided, a credit reporting agency (CRA) is authorized to provide credit ratings to any inquiring lending agency (LA). Once the LA receives credit scores and credit approval, the associated transaction is typically executed. The only real barrier available for an individual is placing a freeze or flag on his credit history. This is typically done only as a result of a previously discovered breach of PPD.

Even the latest protective measures taken by corporations and the U.S. government fail to provide substantively more than reactive procedures to contain damages from, or produce statistics on, identity theft. The Federal Trade Commission, in its Gramm-Leach-Bliley Safeguards Rule, does require corporations to individually come up with plans to defend against identity theft. However, there is no mandate for the development of a comprehensive consumer protection system that can be integrated into U.S. or global markets.

Therefore, it would be highly desirable to have a mechanism and infrastructure affording individuals with greater control over access to their credit information, and the execution of transactions in their names.

### BRIEF DESCRIPTION OF THE DRAWINGS

Features and advantages of embodiments of the invention will become apparent from the following detailed description in which:

FIG. 1 is an exemplary representation of the process by which a potential subscriber registers with and activates an account with the CAC.

FIG. 2 is an exemplary representation of the process by which a subscriber changes his initial Account Password as established by the CAC or TTP.

FIG. 3 is an exemplary representation of the process by which a subscriber may re-establish control over his account in the event of loss of the Account Password.

FIG. 4 is an exemplary representation of the process by which a subscriber may create a TEAP and its associated TEAP parameter certificate (TPC).

FIG. 5 is an exemplary diagram of one possible format for a TEAP Parameter certificate (TPC).

FIG. 6 is an exemplary diagram of one possible format for a Transaction Approval (TA) certificate.

FIG. 7 is an exemplary diagram of one possible format for a Transaction Denial (TD) certificate.

FIG. 8 is an exemplary representation of the process by which a Credit Reporting Agency (CRA) may receive authorization to supply a subscriber's credit data by passing a TEAP, obtained from the Lending Authority (LA), through to the Centralized Consumer Access & Authorization Control Center (CAC).

FIG. 9 is an exemplary representation of another process by which a participating Lending Authority (LA) may receive authorization to perform a transaction under the subscriber's name, by submitting a TEAP directly to the CAC.

FIG. 10 is an exemplary representation of the process by which a keychain dongle TEAP generator may be used to authorize a credit card transaction.

### DETAILED DESCRIPTION

To mitigate the likelihood of identify theft, embodiments of the invention provide both dynamic and systematic transaction control mechanisms. For instance, according to one embodiment of the invention, an individual establishes an account with a centralized entity (hereinafter referred to as the Centralized Consumer Access & Authorization Control Center “CAC”) and sets up one or more passwords that are established for a finite number of uses (e.g., a single, one-time use). The password, hereinafter referred to as a transaction-event authorization password (TEAP), along with usage parameters, moderates the ability of financial institutions to undertake various types of transactions in that consumer's name.

As a result, a financial institution, such as a credit reporting agency (CRA), merchant, bank, or lending authority (LA) for example, would need to verify consumer identity and intent by testing TEAPs through the CAC in order to proceed with any new financial transaction such as a credit, loan, benefits, or employment transaction in that consumer's name.

In the following description, certain terminology is used to describe features of the invention or of a system deploying the invention. For example, “software” may be code or a series of instructions adapted as firmware or configured as part of an operating system, executable program, a downloadable applet, a routine or the like. The software can be stored in any type of machine readable medium and executed by a processing unit. Examples of “machine readable medium” include a programmable electronic circuit, a semiconductor memory device including volatile or non-volatile memory, a floppy diskette, an optical disk (e.g., CD, DVD), a hard disk drive, etc. Examples of a processing unit comprise a microprocessor, a digital signal processor, a micro-controller, a state machine, an application specific integrated circuit or the like.

In addition, the term “connection” represents a secure or insecure communication pathway to enable information to be transmitted between two or more points. The communication pathway may be established using a variety of transmission mediums such as cable, optical fiber, electrical wire, wireless signaling (e.g., channels) or the like.

The detailed description features a number of acronyms that are set forth below for referencing convenience:
CAC—Centralized Consumer Access & Authorization Control Center
CRA—Credit Reporting Agency
LA—Lending Authority
TEAP—Transaction-Event Authorization Password
TPC—TEAP Parameter Certificate
PPD—Private Personal Data
TA—Transaction Approval
TD—Transaction Denial
QA—Query Approval
QD—Query Denial
TTP—Trusted Third Party.

Herein, the systematic control mechanism features a Centralized Consumer Authorization and Access Control Center (CAC). The CAC acts as an agent for individuals to protect against fraudulent use of their identities. The CAC is linked to financial, governmental, and employment institutions and provides a centralized identity verification and transaction authorization service.

The dynamic control mechanism is a nested password system that individuals control and regularly refresh through the services and infrastructure of the CAC. The password nest consists of two types of passwords: Account Passwords and Transaction-Event Authorization Passwords (TEAPs). The TEAP is digitally linked through certification techniques to boundaries moderating its use. These inconstant password mechanisms eliminate the vulnerabilities created by sole reliance on PPD.

Replacing PPD, the TEAP becomes one of the principal data reviewed by institutions at the time of an actual transaction. The TEAP is verified in real time through the infrastructure and services of the CAC. If successful, the verification process results in issuance of a Transaction Authorization (TA) certificate by the CAC. Issuance of the TA certificate allows the institution to proceed with the transaction or application process. If unsuccessful, the transaction is rejected by the CAC and a Transaction Denial (TD) certificate is issued.

Upon receipt of a TD certificate, the institution is not allowed to proceed with the transaction. In response to the issuance of a TD certificate, the institution could request that the consumer take a moment and establish a TEAP for the transaction, or if circumstances warrant, appropriate officials could be called in to pursue further investigation of the applicant. Regardless of the outcome of the verification process, the resultant certificate is also sent (e.g., by email) to the CAC Account owner. In the event that a fraudulent transaction is being attempted, the true owner of the identity will be alerted.

As stated above, a successful TEAP authentication results in the issuance of a TA certificate to the institution, copied to the consumer, and maintained on file at the CAC. The TA certificate includes one or more of the following: a CAC digital signature or credential; the consumer's name; names of all institutions authorized under the TEAP; TEAP creation & expiration dates; a maximum authorized amount (e.g., a dollar limit); and information associated with the date, time, institution, and/or specifics of the actual application & TEAP verification. TA certificates are invaluable and will likely be used in order to prove that CAC services were used to verify the identity of the applicant.

In certain situations, the consumer may wish to employ a two-operation process, in which a first TEAP is used to prove identity and authorize access to financial/credit data (e.g., credit report, bank account balance, credit card histories, etc.) that is important in the application process, while a second TEAP is used to authorize consummation of the transaction once the application process has been satisfactorily completed. This process allows the consumer to initiate several parallel applications without unintentionally authorizing the actual transactions.

In this case, the scope of the first TEAP as specified in the CAC-issued TA certificate will limit its usage to accessing information and will not allow completion of the transaction per se. This type of limited-scope TA certificate might be thought of as a Query Approval (QA) certificate as the transaction-event in question would only be the query as opposed to the actual contractual arrangement. Denial of such a query would result in the issuance of a Query Denial (QD) certificate. A second TA certificate will be issued to allow the actual transaction only upon presentation of the second TEAP with appropriate scope.

TD certificates include similar information and could be used as evidence by the individual against the financial/governmental/employment institution should those institutions ignore the TD certificate and provide services to an unverified applicant under the name of the consumer.

I. Procedural Details

A. Establishing a CAC Account

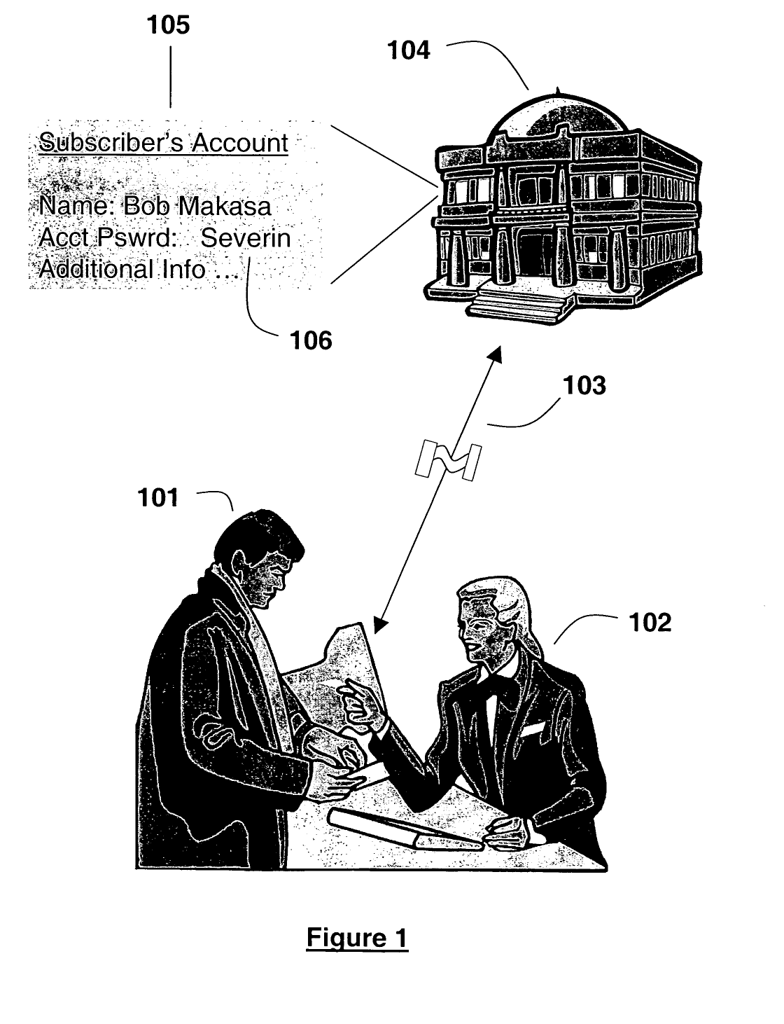

Referring to FIG. 1, to establish a CAC account and an initial Account Password, a subscriber 101 proceeds to a bank or other Trusted Third Party (TTP) institution. A CAC account could only be established via an authenticated TTP institution. Subscriber 101 presents sufficient authenticated government-issued ID and PPD to confirm his identity to a representative of TTP institution 102. TTP institution 102 establishes a connection through a secured network 103 to CAC 104, which performs a mutual-authentication protocol and proceeds to set up a CAC account 105 in the subscriber's name. TTP institution 102 also establishes an initial Account Password 106 with CAC 104 for the individual's new CAC account. Any CAC fees or credential documents due from subscriber 101 would be collected by TTP representative 102. Credential documents may be used by institutions subsidizing CAC services in order to identify and authorize individuals that they wish to subscribe into the CAC system.

In the event that subscriber 101 forgets his or her Account Password 106, similar procedures of identification through TTP institution 102 are available to allow reestablishment of Account Password 106 by TTP institution 102. Subscriber 101 is directly notified by CAC 104 of such activity via a connection excluding TTP institution 102 (e.g., by direct email to subscriber 101).

B. CAC Account Renewal and Cancellation

1. Voluntary Termination

In the event that a subscriber wishes to terminate his CAC account, he may either let the account lapse through non-payment of a subscription fee, in which CRC account 105 will be automatically terminated at the end of the subscription period as described below under “involuntary termination,” or he may terminate CRC account 105 by logging into the account and requesting termination. In this case, CAC 104 will respond by contacting subscriber 101 (e.g., contact by email, phone, mail, etc.) to confirm the requested action.

2. Involuntary Termination

CAC subscriber account services may be cancelled for non-payment of the subscription fee within a subscription period or non-renewal at the end of the subscription period. CAC subscriber account services may also be cancelled for gross misrepresentation of personal information discovered subsequent to the establishment of CAC account 105.

In the case of non-payment of the subscription fee, subscribers are notified in writing by CAC 104 prior to service termination. CAC services are no longer provided after the account termination date.

In the case of non-renewal, service terminates at the end of the subscription period. Renewal notice(s) are issued prior to service termination. Termination notices are sent to the billing address and/or address of record for the subscriber. CAC services are no longer provided after the account termination date.

C. Password Use and Maintenance

1. Account Password

The subscriber uses the Account Password to access and review information contained in his CAC account, make changes to information stored in the account (e.g., email address, mailing address, etc.), and create and maintain TEAPs. It is also needed to change the Account Password itself. Despite the simplified representation shown in the Figures, only a “derivative” version of the Account Password is stored in the account, allowing authentication of the actual Account Password when later presented. The derivative version may be a result of a one-way hash function being performed on the originally chosen Account Password or a portion thereof.

The subscriber would change his initial TTP-established Account Password soon after initiating his account with the CAC and then, for enhanced security, on a regular basis thereafter.

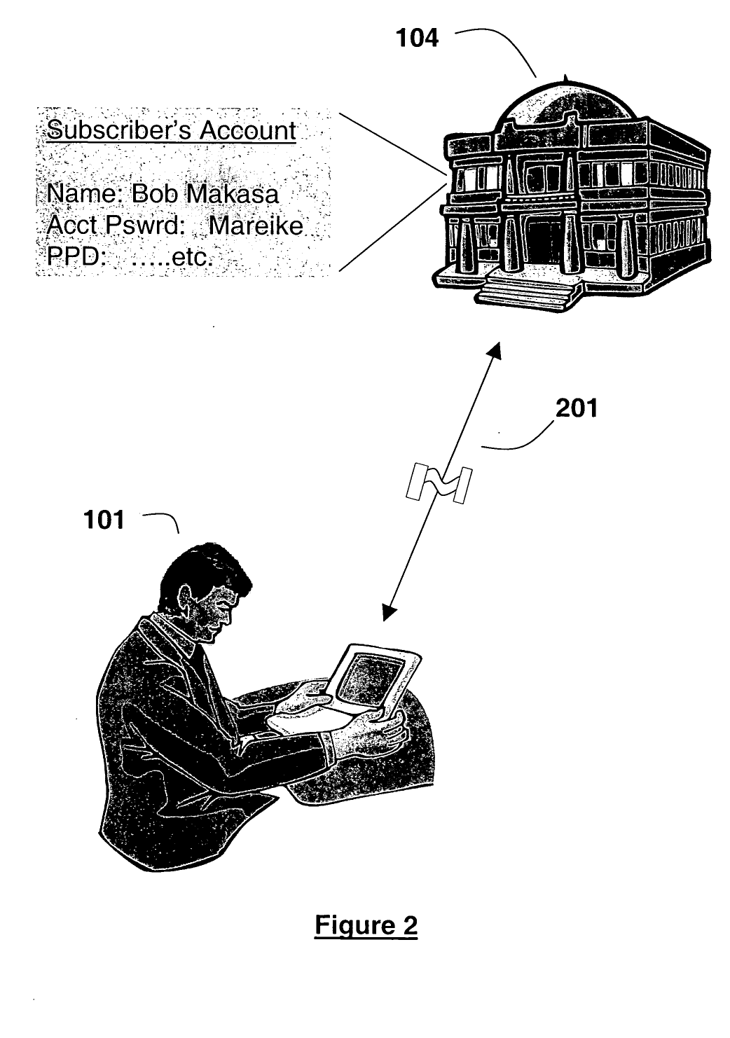

To change the Account Password, as shown in FIG. 2, subscriber 101 connects to CAC 104 either by a second network connection 201, as shown, or at a terminal at the TTP institution. According to another embodiment of the invention, although not shown, changes could also be made from a subscriber's home landline telephone. For any particular method of communication with CAC 104, best-known methods for security and authentication are utilized. Updates over cellular telephones, PDA's, 2-way pagers, and other (non-home-based) landline phones may be permitted based on availability of appropriate secure communications techniques.

Once connected to CAC 104, subscriber 101 provides his CAC Account Number, optionally some portion of his PPD, and his current Account Password. After the current Account Password has been verified (e.g., undergoes an operation to produce a result being compared to the stored “derivative” version of the Account Password), the subscriber is prompted for a new alphanumeric Account Password and confirmation thereof. The password format is based on best-known methods for security.

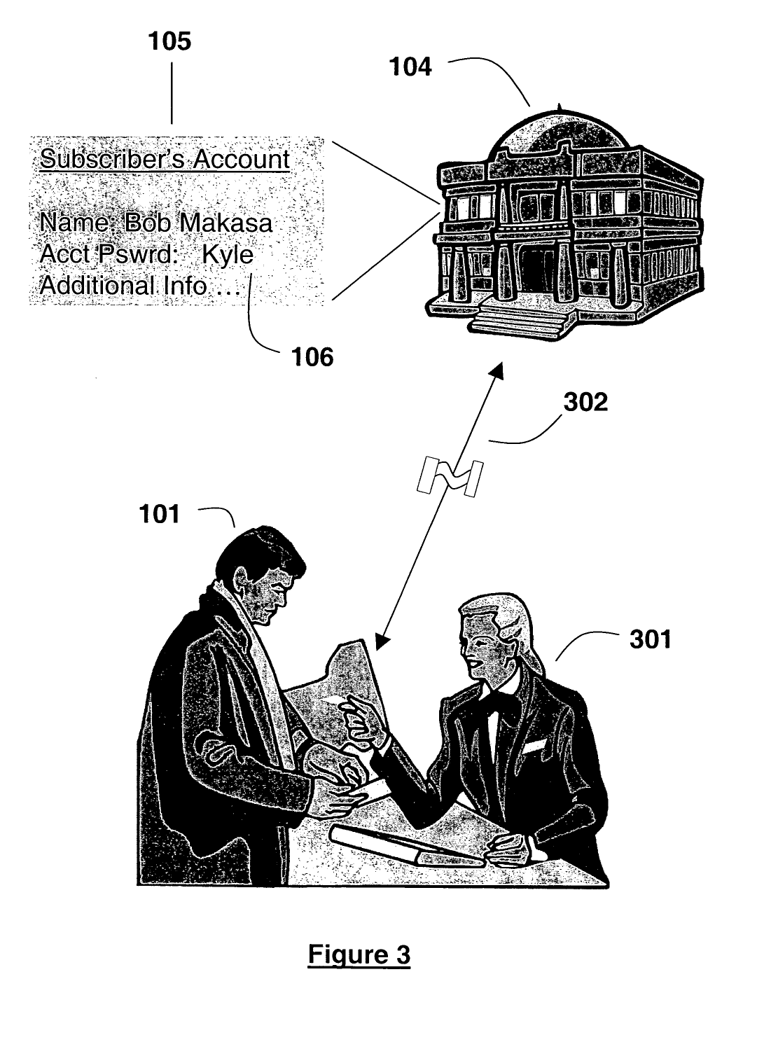

Referring now to FIG. 3, a procedure is shown enabling subscriber 101 to regain access to his CAC account in the event he loses or forgets his Account Password. As in FIG. 1, subscriber 101 goes to a Trusted Third Party (TTP) institution 301 (not necessarily the same TTP used to create the account) and provides his identification, PPD and CAC account number to a representative of TTP institution 301. TTP institution 301 establishes a secure connection 302 to CAC 104 and replaces Account Password 106 on subscriber's account 105 with a new temporary password. Subscriber 101 changes this password in a timely fashion according the operations of FIG. 2.

2. TEAP

A TEAP may be created by the subscriber, to be later provided by the subscriber to an entity (e.g., car dealer, Medicare service provider, bank loan officer, etc.) with which the subscriber may conduct a transaction. Multiple TEAPs may be created and simultaneously exist. The Account Password is needed to create and/or change TEAPs.

Cryptographically bound to the TEAP in the form of a TEAP parameter digital certificate (TPC) are subscriber-established parameters to limit the field of use (or scope) for that particular password. Each TPC is digitally signed by the CAC to enable strong authentication. According to one embodiment of the invention, the TEAP itself is not stored in the CAC or its certificates. Despite the simplified representation shown in the Figures, only a “derivative” version of the TEAP (e.g., hashed representation) is stored in the account, allowing authentication of the actual TEAP when later presented.

TPCs enable the subscriber to establish boundaries for the TEAP's use. Boundaries could include number of uses and/or time to expiration; specific institution(s) authorized under the TEAP; transaction types (e.g., credit history access or loan creation, etc.); and dollar limitations. Password and TPC format is based on best-known methods for security. TEAPs can be managed on-line, by phone, or via a secure transaction terminal located at a TTP or the institution engaged in the transaction. Again, best-known methods for security and authentication are used on any communications link.

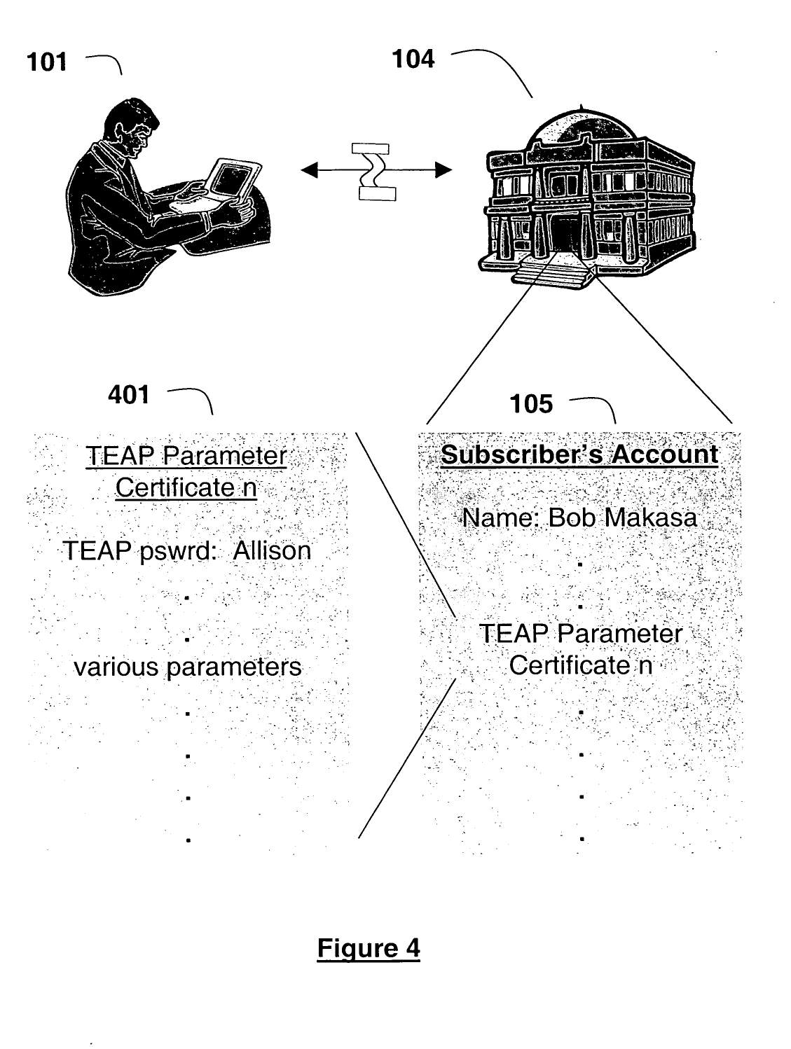

As shown in FIG. 4, to create or change a TEAP or its associated TPC 401, subscriber 101 logs into his account 105 at CAC 104 using the CAC account number, optionally PPD, and Account Password. At the TEAP Maintenance Menu/Screen, subscriber 101 enters the alphanumeric TEAP, a confirmation of the password (if new), and creates or modifies the parameters associated with the password. Note that if the parameters of an existing TEAP (for which a TPC has been created) are modified, the existing TPC is cancelled and subscriber 101 may select a new value for the TEAP. This prevents the creation of multiple TPCs with matching associated TEAPs.

Once the subscriber has created the TEAP and specified all its associated parameters, this data is incorporated into a TEAP Parameter Certificate (TPC) 401 and digitally signed by CAC 104. TPC 401 is stored within the subscriber's account and also copied (e.g., by email) to subscriber 101 (if so desired) so that subscriber 101 may archive it independently. Of course, as multiple TPCs may exist and since the TEAP is never stored with it, a serial number is assigned to each TPC as it is created to uniquely identify it and help the subscriber manage them.

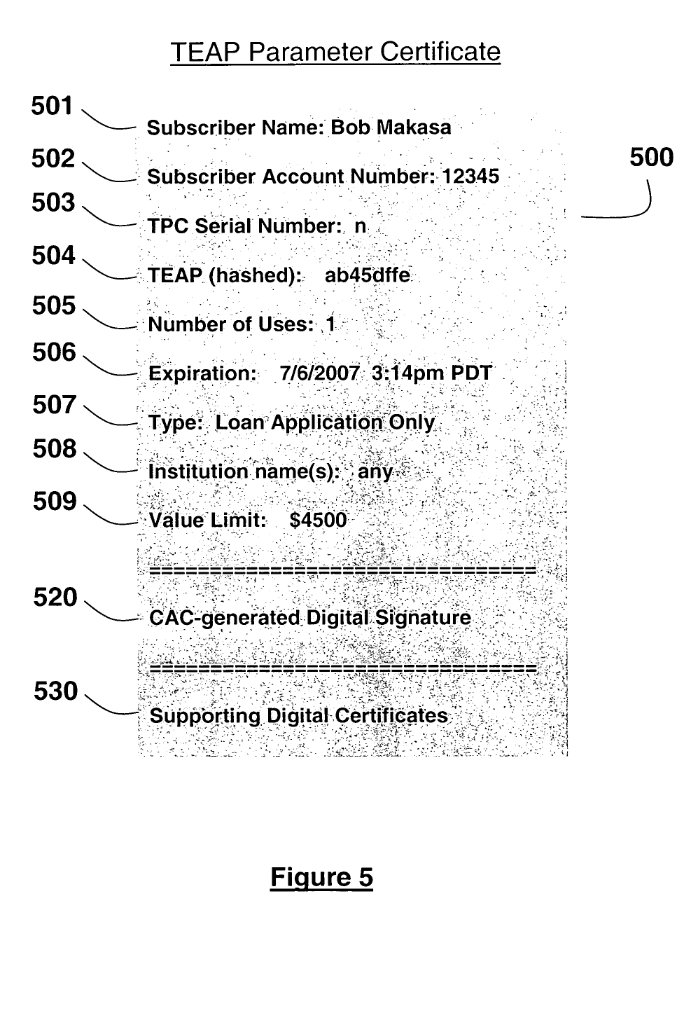

FIG. 5 is an exemplary embodiment of a format for TPC 500, which is identical to TPC 401 of FIG. 4. According to this embodiment, TPC 500 comprises one or more of the following elements: a subscriber's name 501 and account number 502, a unique serial number 503 assigned by the CAC, a hashed representation 504 of the associated TEAP, the number of usages permitted 505, an expiration date and time 506, a transaction-type identifier 507, institution name 508, transaction value limit 509, etc. The elements 501-509 are referred to as the “main body” of TPC 500.

As further shown, TPC 500 also comprises a CAC digital signature 520. Digital signature 520 is computed over the “main body” of TPC 500. One or more digital certificates 530 may be attached to TPC 500 in order to simplify the certificate validation process. Digital certificates 530 would be part of a standard public key-based digital certificate hierarchy.

The subscriber creates/activates these TEAPs/TPCs on an as-needed basis to provide for authorization of a particular transaction(s).

When any third party (e.g., a Lending Authority) attempts to execute a transaction in the name of a CAC-subscriber, a TEAP is needed for approval of that transaction. If the TEAP submitted is not valid (either inactive or simply incorrect), any request processed through the CAC is denied.

D. Account Management Operation Logging

For any and all account management operations that occur, a detailed log (which may be, optionally, cryptographically time-stamped) is maintained in the subscriber's account and a separate confirmation message is sent to the subscriber. These operations include, for example, all attempts (successful or unsuccessful) to access the account, changes to password, creations or modifications of TEAPs/TPCs, changes in account preferences (e.g., email address, mailing address), any submissions of a TEAP for verification, etc.

II. Implementation of System and Services

The CAC and Nested Password system of this invention may be embodied on a limited basis or unlimited basis. In either case a rollout phase is needed, necessitating a flagging mechanism to identify those individuals subscribing to CAC services.

A. Limited Credit/Loan Embodiment

The limited credit/loan embodiment provides an access/authorization control point only at the Credit Reporting Agency (CRA). Consumer participation is based on voluntary subscriptions. Once a subscription to CAC services is established, the CAC synchronizes with each CRA to place a flag on that subscriber's credit history data. The flag indicates the requirement for presentation of a valid TEAP and receipt of a Transaction Authorization (TA) certificate from the CAC prior to release of credit data. CRAs need to receive the TA certificate, which demonstrates authorization for release of the subscriber's data if any subsequent investigations are made into a particular credit application.

Any Loan Authority (LA) requesting credit data for a CAC-subscribed individual may provide a TEAP to the CRA. The CRA, in turn, verifies the TEAP and parameters with the CAC and thereby obtains the requisite TA certificate prior to releasing the consumer credit data. If a consumer does not present the correct TEAP, a Transaction Denial (TD) certificate is issued and no credit data is forwarded to the LA. If the consumer has not set up an account with the CAC, his credit history is not flagged as requiring a TA and the CRA proceeds with the credit request using traditional methods.

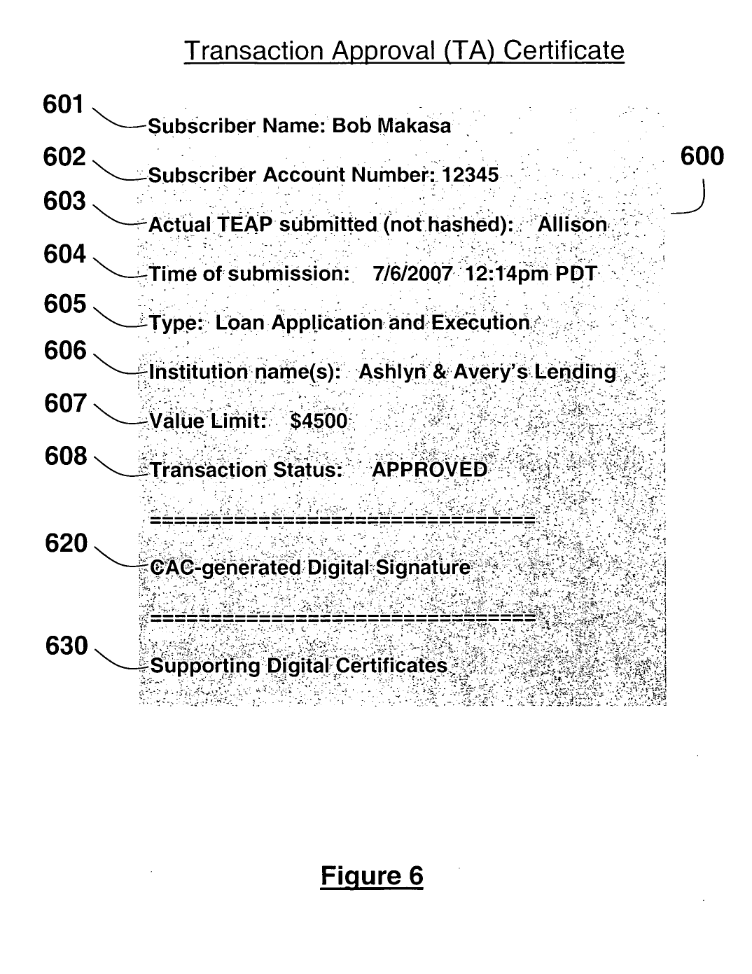

FIG. 6 is an exemplary embodiment of a format for a Transaction Approval (TA) certificate 600. TA certificate 600 includes one or more elements forming the main body of TA certificate 600. These elements may include, but are not limited or restricted to any combination of the following: the subscriber's name 601, the account number 602, the actual TEAP submitted (non-hashed) 603, the date and time of submission 604, the type of transaction as submitted 605, the name of the Lending Authority 606, the value of the transaction as submitted 607, the status of the transaction 608 (in this case, APPROVED), etc.

As shown in FIG. 6, the next element of TA certificate 600 is a digital signature 620 computed by the CAC over the main body of TA certificate 600. Finally, while not formally part of TA certificate 600, one or more supporting digital certificates 630 may be attached to TA certificate 600 in order to simplify the certificate validation process.

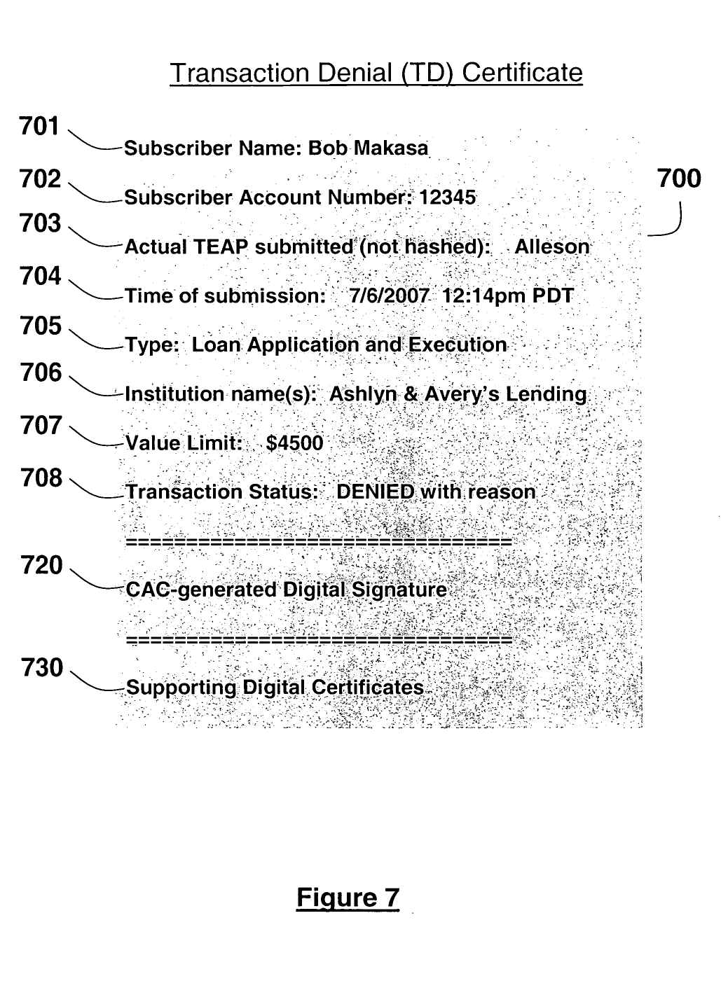

FIG. 7 is an exemplary embodiment of a Transaction Denial (TD) certificate 700. TD certificate 700 may include, but is not limited or restricted to one or more of the following elements forming the main body: the subscriber's name 701, the account number 702, the actual TEAP submitted (non-hashed) 703, the date and time of submission 704, the type of transaction as submitted 705, the name of the Lending Authority 706, the value of the transaction as submitted 707, the status of the transaction 708 (in this case, DENIED along with the reason for the denial), etc.

The next element of TD certificate 700 is a digital signature 720 computed by the CAC over the main body of TD certificate 700. Finally, while not formally part of TD certificate 700, one or more supporting digital certificates 730 may be attached to TD certificate 700, which may simplify the certificate validation process.

This embodiment does not require any new procedures from the LAs, other than requesting TEAPs from those consumers subscribed to the CAC, and providing those passwords to the CRAs. CRAs, however, may establish procedures and secure communications links with the CAC.

B. Example of “Limited” Embodiment

Bob Makasa, a CRC subscriber, is planning to buy a new car from a dealership. Bob needs a loan for the car. Prior to going to the dealership, Bob goes online to the CAC web site. In accordance with the procedures outlined in FIG. 4, Bob enters his CAC Account Number, his Account Password and optionally his PPD. He then creates a TEAP with parameters that authorize the dealership's LA and expires in a predetermined number of hours (e.g., 6 hours). The CAC digitally signs the TEAP Parameter Certificate and retains it in Bob's account in the CAC database.

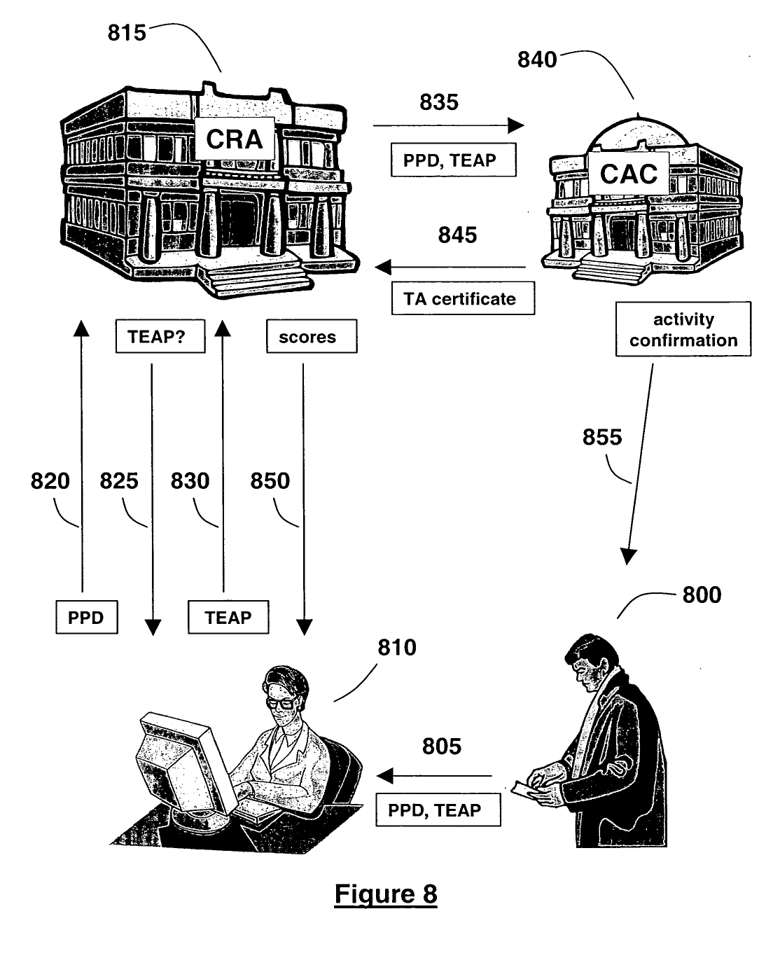

Next, as shown in FIG. 8, Bob 800 provides his PPD and TEAP in to the dealership's lending authority (LA) 810 (block 805). LA 810 contacts a credit reporting agency (CRA) 815 and provides the PPD (block 820). Because Bob's credit history account is flagged to show that he is a CAC-subscriber, CRA 815 requests the TEAP (and, possibly, some transaction parameters) from LA 810 (block 825), which LA 810 then supplies (block 830). Of course, it is contemplated that the PPD and TEAP may be provided concurrently in order to avoid CRA 815 from initiating a prompt message for the TEAP.

In block 835, CRA 815, in turn, provides the PPD, TEAP, and (optionally) some subset of the actual transaction parameters to CAC 840. CAC 840 verifies the TEAP, validating it against the scope specified in its associated parameter certificate, and optionally compares actual transaction parameters with those permitted by the parameter certificate.

If they match, a TA digital certificate is created, signed by CAC 840 and returned to CRA 815 (block 845). This authorizes CRA 815 to provide credit data (e.g., credit history, FICO score, etc.) to LA 810. CRA 815 checks the validity of the TA certificate using standard cryptographic techniques and returns the credit scores to LA 810 (block 850). LA 810 completes the loan application evaluation process using traditional methods.

If they do not match, a TD certificate is created, signed by CAC 840 and returned to CRA 815. No data is authorized to be sent from CRA 815, and the transaction terminates.

In either case, CAC 815 logs the activity and sends an activity confirmation message to the subscriber in block 855.

C. Unlimited Credit/Loan Embodiment

The unlimited credit/loan embodiment enables any LA to verify a CAC subscriber's authorization of new credit directly through the CAC. LA's will establish relationships with the CAC much like the CRA-CAC relationships described in the limited embodiment.

An individual wishing to establish an account or credit with a participating LA has his PPD submitted to the CAC by the LA to determine if that person was a subscriber to CAC services. If the individual shows up as a CAC subscriber, he will need to present a TEAP. The LA tests the TEAP and parameters with the CAC. The LA receives a TA certificate if the TEAP and parameters are determined to be valid, or a TD certificate if either the password or parameters are not valid. If the individual is not a CAC subscriber, the LA may proceed with the transaction using traditional credit evaluation methods.

D. Example of “Unlimited” Embodiment

Alice, a CAC subscriber, is planning to buy a new house for which she needs a mortgage. Prior to meeting with the lending authority's loan officer, Alice goes online to the CAC website. In accordance with the procedures outlined in FIG. 4, Alice enters her CAC Account Number, optional PPD, and her Account Password. She then creates a TEAP with parameters that authorize the mortgage company and expires in 3 days. The CAC digitally signs the TEAP Parameter Certificate and retains it in Alice's account in the CAC database.

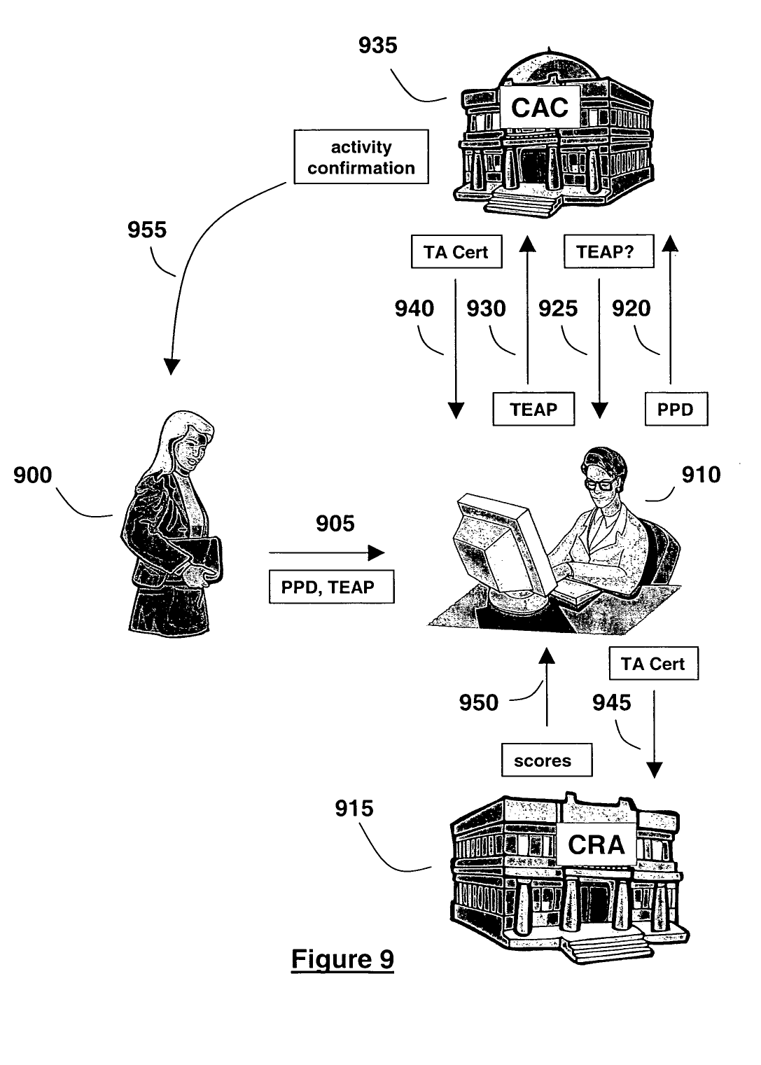

As shown in FIG. 9, Alice 900 provides her PPD and TEAP to a LA 910 representative as shown in block 905. LA 910 contacts CAC 935 and provides the PPD (block 920). Because Alice is indeed a CAC-subscriber, CAC requests the TEAP (and, possibly, some transaction parameters) from the LA 910 (block 925), which is supported by LA 910 (block 930). CAC 935 verifies the TEAP, validating it against the scope specified in its associated parameter certificate, and optionally compares actual transaction parameters with those permitted by the parameter certificate.

If they match, a TA digital certificate, which is optionally time-stamped, is created and signed by CAC 935. In block 940, the TA digital certificate is returned to LA 910, thereby authorizing LA 910 to proceed with the transaction. LA 910 checks the validity of the TA certificate using standard cryptographic techniques and proceeds with the transaction.

If credit information is needed, the TA certificate is sent to CRA 915 (block 945). CRA 915 checks the validity of the TA certificate using standard cryptographic techniques and returns the credit data to LA 910 (block 950). LA 910 completes the loan application evaluation process.

If they do not match, a TD certificate is created and signed by CAC 935 and returned to LA 910 and the transaction terminates.

In either case, CAC 935 logs the activity and sends an activity confirmation message to Alice 900 in block 955.

E. Government Services and Employment Embodiment

In yet another embodiment, the CAC system extends beyond protection of consumer-based credit and banking transactions into the realm of preventing fraudulent access to government services benefits. The system functions substantially the same as described above. Government agencies or entities operating under the auspices of the government (e.g., prescription drug or equipment suppliers) connect to the CAC to verify beneficiary identity and intent through the use of TEAP and TPC mechanisms. This would help, for example, to prevent fraudulent Medicare billing for never-ordered, never-delivered equipment in the name of an unsuspecting individual.

Similarly, employers would contact the CAC to verify prospective employee identification, intent and potentially other relevant information.

III. Alternative Embodiments

It is further contemplated that the TEAP may be utilized at the time of online registration with a service provider such as EBAY® or the like. This would enable the service provider to rely on the fact that it is really communicating with a consumer claimed as opposed to an identity thief who has stolen someone's credit card number and other PPD. To continue this embodiment, it is further contemplated that the service provider may display an icon showing that the seller or buyer (bidder) is a CAC-authenticated entity or individual.

It is further contemplated that a “keychain dongle” may be provided that produces a series of TEAPs from an initial seed, displaying a new one each time the subscriber performs an action. The dongle would be serialized to the subscriber and synched to the CAC. Each TEAP would authorize a generic, pre-programmed type of transaction (e.g., credit charge up to a certain dollar amount).

When such a generated TEAP was received by the CAC, it would be matched against the expected series for validity. Moreover, multiple buttons on the dongle may be implemented and associated with different TEAP sequences, each representing a different level of authorization.

The keychain dongle TEAP-generator allows the user to quickly and conveniently create TEAPs even for the most common transactions without having to connect to his CAC account. In effect, the dongle would be generating one-time use, unique signatures on behalf of the user for the purpose of authorizing transactions.

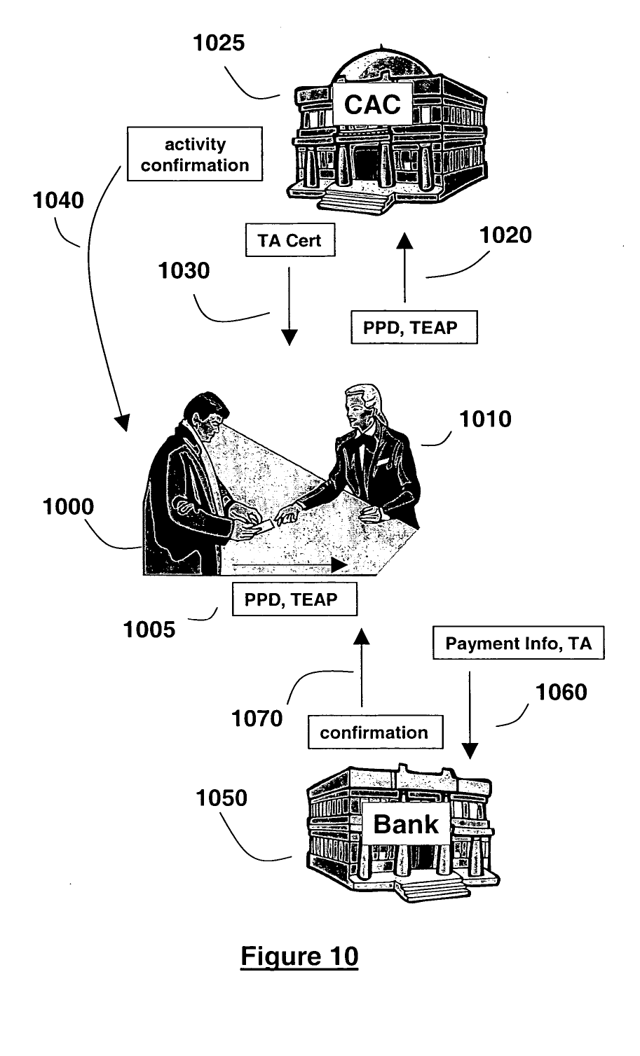

An example flow is shown in FIG. 10, wherein Bob Makasa 1000 uses his credit card or other monetary instrument to make a $35 purchase. In block 1005, Bob uses his TEAP-generator to create a new TEAP authorizing a payment of up to $50. Alternatively, information could be provided to the TEAP-generator that would allow the creation of an even more tailored TEAP in the exact amount of the purchase ($35) and/or to the specific merchant. In this case, however, the TEAP is of a predetermined format and value.

As shown in block 1005, Bob provides his account information (e.g. credit card number) and TEAP to the merchant 1010. This may be completed manually or by electronic means (e.g. a wireless connection).

Merchant 1010 passes this information through to the CAC 1025 where the submitted TEAP is validated against similarly generated TEAP values within the CAC (block 1020). Based on the result, a TA or TD certificate is generated and returned to the merchant in (block 1030). Concurrently, the account activity is logged and confirming notification is sent to the subscriber 1000 (block 1040).

After receipt of the TA, merchant transmits payment information and TA to the financial institution 1050 for processing (block 1060). When the transaction has completed at the financial institution, a confirmation is sent back to the merchant (block 1070). Obviously, such a keychain dongle could be integrated with other portable devices such as laptops, PDAs, cell phones, etc.

It is further contemplated that a credit card issuing or processing institution could implement the TEAP method directly, operating as both the financial institution and the CAC.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A method comprising:
transmitting a password from a first financial institution to a centralized entity for verification of the subscriber, the password being unique to a subscriber being a party to a transaction;
comparing the password to stored information at the centralized entity; and
providing a certificate by the centralized agency, the certificate authorizing the first financial institution to conduct the transaction with a second financial institution.

2. The method according to claim 1, wherein the certificate authorizes the first financial institution, being a lending agency, to obtain a credit report from the second financial institution being a credit reporting agency.

3. The method according to claim 1, wherein prior to transmitting the password, the method further comprises creating the one-time use password.

4. The method according to claim 1 further comprising:
alternatively providing a second certificate by the centralized agency, the second certificate precluding the first financial institution from proceeding with the transaction.

5. The method according to claim 1 further comprising:
conducting the transaction with the second financial institution by accessing information associated with the subscriber;
transmitting a second password from the first financial institution to the centralized entity, the second password being unique to the subscriber;
comparing the second password to stored information at the centralized entity; and
providing a second certificate by the centralized agency, the second certificate authorizing the first financial institution to conduct a second transaction being a financial transaction.

6. The method according to claim 1, wherein the comparing of the password to stored information at the centralized entity includes conducting an operation on the password to produce a result differing from the password and comparing the result to the stored information.

7. The method according to claim 1, wherein the stored information includes (i) a main body that comprises a name of the subscriber, a derivative representation of the password, a number of usages permitted for the password, an expiration time period for the password, and (ii) a digital signature of the main body.

8. The method according to claim 7, wherein the main body further includes at least two of the following: an identifier to identify a type of the first transaction, an identifier as to which financial institution are permitted to receive the certificate, and a monetary limit of the first transaction.

9. The method according to claim 1, wherein the main body further includes a name of the subscriber, an account number at the centralized entity, a name of the first financial institution, and a status of the transaction.

10. A method comprising:
transmitting a password to a centralized entity for verification of the subscriber, the password being unique to a subscriber being a party to a financial transaction;
comparing data being either the password or a derivative of the password to stored information at the centralized entity; and
providing a certificate by the centralized agency, the certificate authorizing access to credit data associated with the subscriber if a match is detected between the data associated with the password and the stored information.

11. The method according to claim 10, wherein the certificate authorizes access to a credit report from a credit reporting agency by the subscriber.

12. The method according to claim 10, wherein prior to transmitting the password, the method further comprises creating the one-time use password having finite number of uses.

13. The method according to claim 10 further comprising:
alternatively providing a second certificate by the centralized agency, the second certificate precluding access to the credit data.

14. The method according to claim 10 further comprising:
accessing the credit data of the subscriber;
transmitting a second password to the centralized entity, the second password being unique to the subscriber;
comparing data being either the second password or a derivative of the second password to stored information at the centralized entity; and
providing a second certificate by the centralized agency, the second certificate indicating that the subscriber is authorized to enter into a contractual based financial transaction.

15. The method according to claim 10, wherein the stored information includes a main body that comprises a name of the subscriber, one of a derivative representation of the password or the password, an expiration time period for the password, and a digital signature of the main body.

16. The method according to claim 15, wherein the main body further includes at least two of the following: a derivative representation of the password, a number of usages permitted for the password, an identifier to identify a type of the financial transaction, an identifier as to which financial institutions are permitted to receive the certificate, and a monetary limit of the financial transaction.

17. The method according to claim 10, wherein the derivative representation of the password being a one-way hash result of the password.

18. A portable apparatus comprising:
means for generating a one-time password; and
an interface providing the password as an output being one of an electrical transmission of the password and a visual display of the password, the password being used for transmission to a centralized entity for verification of the subscriber, and in response, return transmission of a certificate by the centralized agency, the certificate authorizing access to credit data of holder of the apparatus.

19. The apparatus of claim 18, wherein the means for generating a one-time password includes a generator to produce a series of passwords from an initial seed of data.
